(19) United States
(12) Patent Application Publication
(10) Pub. No.: US 2013/0275699 A1
(43) Pub. Date: Oct. 17, 2013

(54) SPECIAL MEMORY ACCESS PATH WITH SEGMENT-OFFSET ADDRESSING

(71) Applicant: Hicamp Systems, Inc., Menlo Park, CA (US)

(72) Inventor: David R. Cheriton, Palo Alto, CA (US)

(21) Appl. No.: 13/829,527

(22) Filed: Mar. 14, 2013

Related U.S. Application Data
(60) Provisional application No. 61/615,102, filed on Mar. 23, 2012.

(51) Int. Cl. G06F 12/00

(52) U.S. Cl. CPC G06F 12/00
USPC 711/162; 711/154

(57) ABSTRACT

Memory access for accessing a memory subsystem is disclosed. An instruction is received to access a memory location through a register. A tag is detected in the register, the tag being configured to indicate which memory path to access. On the event that the tag is configured to indicate that a first memory path is used, the memory subsystem is accessed via the first memory path. In the event that the tag is configured to indicate that a second memory path is used, the memory subsystem is accessed via the second memory path.

### CROSS REFERENCE TO OTHER APPLICATIONS

This application claims priority to U.S. Provisional Patent Application No. 61/615,102 (Attorney Docket No. HICAP011+) entitled SPECIAL MEMORY ACCESS PATH WITH SEGMENT-OFFSET ADDRESSING filed Mar. 23, 2012 which is incorporated herein by reference for all purposes.

### BACKGROUND OF THE INVENTION

A conventional modern computer architecture provides flat addressing of the entire memory. That is, the processor can issue a 32-bit or 64-bit value that designates any byte or word in the entire memory system. Segment-offset addressing has been used in the past to allow addressing a larger amount of memory than could be addressed using the number of bits stored in a normal processor register, but had many disadvantages.

Structured and other specialized memory provides advantages over conventional memory, but a concern is the degree to which prior software can be re-used with these specialized memory architectures.

Therefore, what is needed is a means to incorporate a special memory access path into a conventional flat-addressed computer processor.

### BRIEF DESCRIPTION OF THE DRAWINGS

Various embodiments of the invention are disclosed in the following detailed description and the accompanying drawings.

FIG. 1 is a functional diagram illustrating a programmed computer system for distributed workflows in accordance with some embodiments.

FIG. 2 is a block diagram illustrating a logical view of a prior architecture for conventional memory.

FIG. 3 is a block diagram illustrating logical view of an embodiment of an architecture to use extended memory properties.

FIG. 4 is an illustration of an example of general segment offset addressing.

FIG. 5 is an illustration of an indirect addressing instruction for prior flat addressing.

FIG. 6 is an illustration of an indirect addressing load instruction with structured memory using a register tag.

FIG. 7 is an illustration of the efficiencies of a structured memory extension.

FIG. 8 is a block diagram illustrating an embodiment of the special memory block using segment-offset addressing.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As stated above, a conventional modern computer architecture provides flat addressing of the entire memory. The processor can issue a 32-bit or 64-bit value that designates any byte or word in the entire memory system.

In the past, so-called segment-offset addressing was used to allow addressing a larger amount of memory than could be addressed using the number of bits that could be stored in a normal processor register. For example, the Intel X86 real mode supports segments to allow addressing more memory than the 64 kilobytes supported by the registers in this mode.

This segment-based addressing had a number of disadvantages, including:
1. limited segment size: for example, segments in the X86 real mode are at most 64 kilobytes, so it is a complication of software to split its data across segments;
2. pointer overhead: each pointer between segments needs to be stored as an indication of segment plus offset within segment. To save space, intra-segment pointers are often stored as simply the offset, leading to two different representations of pointers; and
3. segment register management: with a limited number of segments, there is overhead in code size and execution time to reload these segment registers.

As a result of these issues, modern processors have evolved to support flat addressing, and the use of segment-based addressing has been deprecated. The residual mechanism is indirect addressing through a register by specifying to load from the address stored in the specified register accessing the location at the (flat) address that is the sum the value contained in the register and optionally an offset.

However, as the size of physical memory has further increased, it is feasible and attractive to store large datasets mostly, if not entirely, in memory. With these datasets, a common mode of accessing them is scanning across large portions of the dataset sequentially or with a fixed stride. For example, a large-scale matrix computation involves scanning the matrix entries to compute the result.

Given this mode of access, the conventional memory access path offered by flat addressing can be recognized to have a number of disadvantages:
1. the access brings cache lines into the data cache for current elements of the dataset, resulting eviction of other lines that have significant temporal and spatial locality of access, while not providing much benefit beyond staging for the data from the dataset;
2. the access similarly churns the virtual memory translation lookaside buffer (TLB), incurring overhead to load references to dataset pages while evicting other entries to make space for these. Because of the lack of reuse for these TLB entries, the performance is significantly degraded; and
3. the flat address access can require 64-bit addressing and very large virtual address space with its attendant overheads, whereas without the large dataset, the program might easily fit into a 32-bit address space. In particular, the size of pointers for all data structures in a program are doubled with 64-bit flat addressing even though, in many cases, the only reason for this large address is flat addressing of the large dataset.

Beyond these disadvantages, the flat addressing access for loads and stores may preclude a specialized memory access path that provides non-standard capabilities. For example, consider an application that uses a sparse matrix with a conventional memory may be forced to handle the sparsity in software using a complex data structure such as a compressed sparse row (CSR), similarly for large symmetric matrices. A special memory path could allow an application to use extended memory properties, such as the fine-grain memory deduplication provided by a structured memory. One example of a structured memory system/architecture is HICAMP (Hierarchical Immutable Content-Addressable Memory Processor) as described in U.S. Pat. No. 7,650,460 which is hereby incorporated by reference in its entirety. Such a special memory access path can provide other properties, as detailed U.S. Pat. No. 7,650,460, such as efficient snapshots, compression, sparse dataset access, and/or atomic update.

By extending rather than replacing the conventional memory, software can be reused without significant rewriting. In a preferred embodiment, some of the benefits of a structured memory can be provided to a conventional processor/system by providing structured capabilities as a specialized coprocessor and providing regions of the physical address space with read/write access to structured memory by the conventional processors and associated operating system as disclosed in related U.S. patent application Ser. No. 12/784,268 (Attorney Docket HICAP001) entitled STRUCTURED MEMORY COPROCESSOR, which is hereby incorporated by reference in its entirety. Throughout this specification, the coprocessor may be referred to interchangeably as “SITE”.

This direction is facilitated by several modern processors being designed with shared memory processor (“SMP”) extensibility in the form of a memory-coherent high-performance external bus. Throughout this specification “interconnect” refers broadly to any inter-chip bus, on-chip bus, point-to-point links, point-to-point connection, multi-drop interconnection, electrical connection, interconnection standard, or any subsystem to transfer signals between components/subcomponents. Throughout this specification “bus” and “memory bus” refers broadly to any interconnect. For example, the AMD Opteron processor supports the coherent HyperTransport™ (“cHT”) bus and Intel processors support the QuickPath Interconnect™ (“QPI”) bus. This facility allows a third party chip to participate in the memory transactions of the conventional processors, responding to read requests, generating invalidations and handling write/writeback requests. This third party chip only has to implement the processor protocol; there is no restriction on how these operations are implemented internal to the chip.

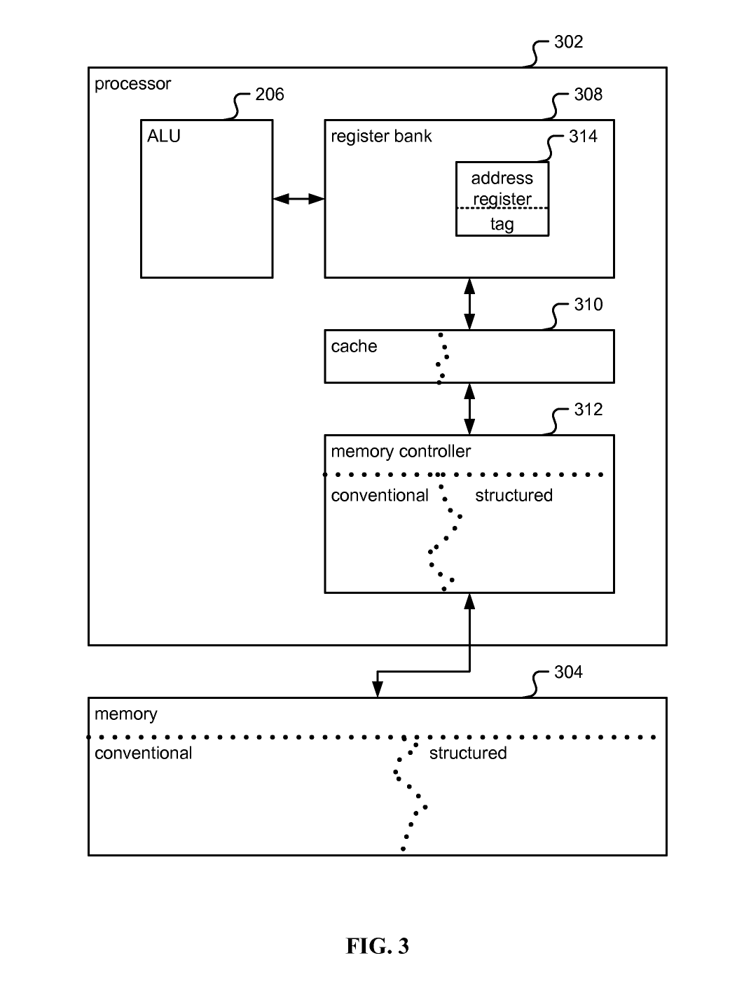

SITE exploits this memory bus extensibility to provide some of the benefits of HICAMP without requiring a full processor with the software support/tool chain to run arbitrary application code. Although not shown in FIG. 3, the techniques disclosed herein may be easily extended to the SITE architecture. SITE may appear as a specialized processor which supports one or more execution contexts plus an instruction set for acting on a structured memory system that it implements. In some embodiments, each context is exported as a physical page, allowing each to be mapped separately to a different process, allowing direct memory access subsequently without OS intervention yet providing isolation between processes. Within an execution context, SITE supports defining one or more regions, where each region is a consecutive range of physical addresses on the memory bus.

Each region maps to a structured memory physical segment. As such, a region has an associated iterator register, providing efficient access to the current segment. The segment also remains referenced as long as the physical region remains configured. These regions may be aligned on a sensible boundary, such as 1 Mbyte boundaries to minimize the number of mappings required. SITE has its own local DRAM, providing a structured memory implementation of segments in this DRAM.

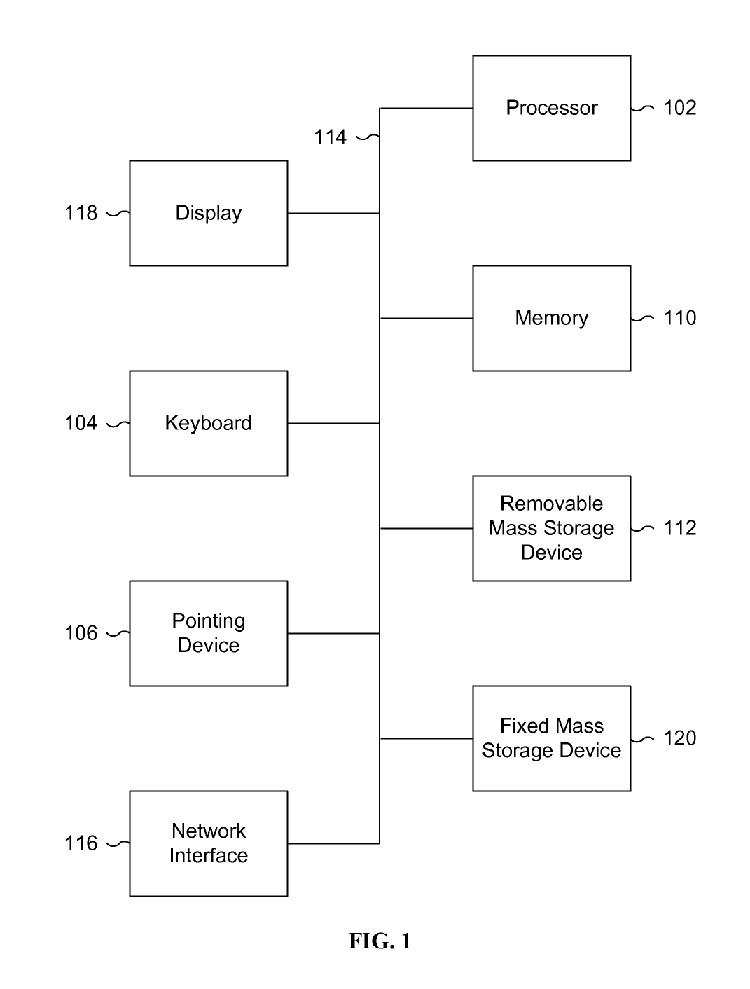

FIG. 1 is a functional diagram illustrating a programmed computer system for distributed workflows in accordance with some embodiments. As shown, FIG. 1 provides a functional diagram of a general purpose computer system programmed to execute workflows in accordance with some embodiments. As will be apparent, other computer system architectures and configurations can be used to execute workflows. Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display 118.

Processor 102 is coupled bi-directionally with memory 110, which can include a first primary storage, typically a random access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data and objects used by the processor 102 to perform its functions, for example programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The block processor 102 may also include a coprocessor (not shown) as a supplemental processing component to aid the processor and/or memory 110. As will be described below, the memory 110 may be coupled to the processor 102 via a memory controller (not shown) and/or a coprocessor (not shown), and the memory 110 may be a conventional memory, a structured memory, or a combination thereof.

A removable mass storage device 112 provides additional data storage capacity for the computer system 100, and is coupled either bi-directionally (read/write) or uni-directionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storage 112, 120 generally store additional programming instructions, data, and the like that typically are not in active use by the processor 102. It will be appreciated that the information retained within mass storage 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a network interface 116, a keyboard 104, and a pointing device 106, as well as an auxiliary input/output device interface, a sound card, speakers, and other subsystems as needed. For example, the pointing device 106 can be a mouse, stylus, track ball, or tablet, and is useful for interacting with a graphical user interface.

The network interface 116 allows processor 102 to be coupled to another computer, computer network, or telecommunications network using a network connection as shown. For example, through the network interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification “network” refers to any interconnection between computer components including the Internet, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, WiFi, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous, heterogeneous systems and/or groups of systems together. Additional mass storage devices, not shown, can also be connected to processor 102 through network interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

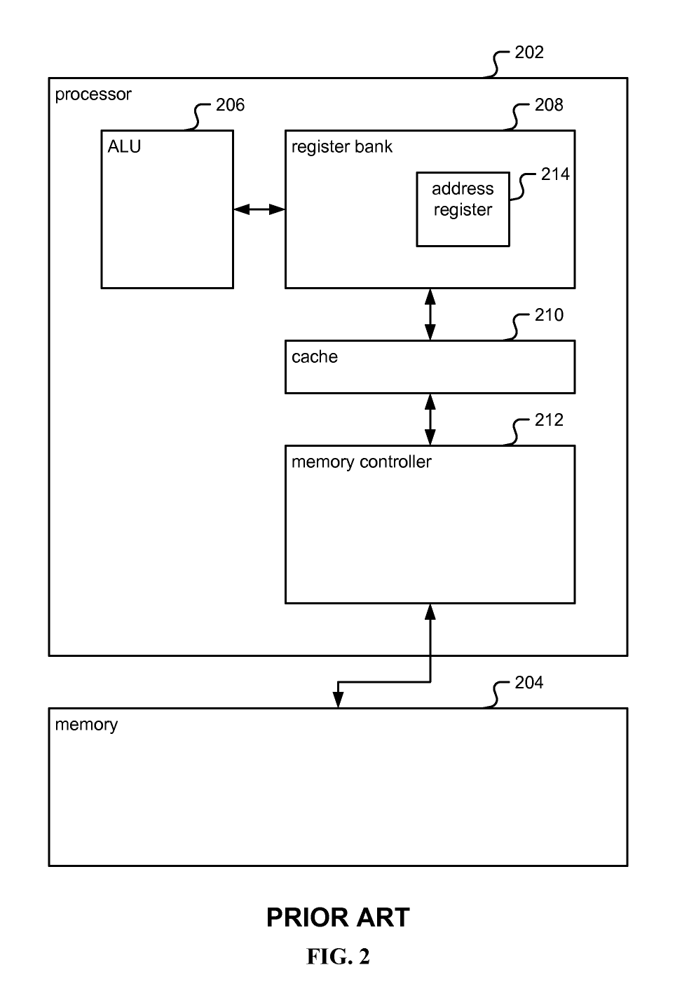

FIG. 2 is a block diagram illustrating a logical view of a prior architecture for conventional memory. In the example shown, processor 202 and memory 204 are coupled together as follows. Arithmetic/Logical Unit (ALU) 206 is coupled to a register bank 208 comprising registers including for example a register for indirect addressing 214. Register bank 208 is associated with a cache 210, which is in turn coupled with a memory controller 212 for memory 210.

FIG. 3 is a block diagram illustrating logical view of an embodiment of an architecture to use extended memory properties. By contrast to memory 204 in FIG. 2, memory 304 comprises a memory dedicated to conventional (for example, flat addressed) memory, and a memory dedicated to structured (for example, HICAMP) memory. A zig-zag line on FIG. 3 (304) indicates that the conventional and structured memory may be clearly separated, interleaved, interspersed, statically or be dynamically partitioned at compile-time, run-time or any time. Similarly, register bank 308 comprises a register architecture that can accommodate conventional memory and/or structured memory; comprising registers including for example a register 314 for indirect addressing that includes a tag. The cache 310 may also be partitioned in a similar manner as memory 304. One example of a tag is similar to a hardware/metadata tag as described in U.S. patent application Ser. No. 13/712,878 entitled HARDWARE-SUPPORTED PER-PROCESS METADATA TAGS (Attorney Docket: HICAP010) which is hereby incorporated by reference in its entirety.

In one embodiment, hardware memory is structured into physical pages, where each physical page is represented as one or more indirect lines that map each data location in the physical page to an actual data line location in memory. Thus, the indirect line contains a physical line ID (“PLID”) for each data line in the page. It also contains k tag bits per PLID entry, where k is 1 or some larger number, for example 1-8 bits. Thus in some embodiments, the metadata tags are on PLIDs, and directly in the data. Similarly, hardware registers may also be associated with software, metadata and/or hardware tags.

When a process seeks to use the metadata tags associated with lines in some portion of its address space, for each page that is shared with another process such that the metadata tag usage might conflict, a copy of the indirect line for that page is created, ensuring a separate per-process copy of the tags as contained in the indirect line. Because the indirect line is substantially smaller than the virtual memory page, the copy is relatively efficient. For example, with 32-bit PLIDs and 64-byte data lines, an indirect line is 256 bytes to represent a 4 kilobyte page, 1/16 the size of the data. Also, storing the metadata in the entries in an indirect line avoids expanding the size of each data word of memory to accommodate tags, as has been done in prior art architectures. A word of memory is generally 64-bits at present. The size of field required to address data lines is substantially smaller, allowing space for metadata, making it easier and less expensive to accommodate the metadata.

Similarly, memory controller 312 comprises logic dedicated to controlling the conventional memory in 304 as well as additional logic dedicated to controlling the structured memory, as will be described in detail in the following.

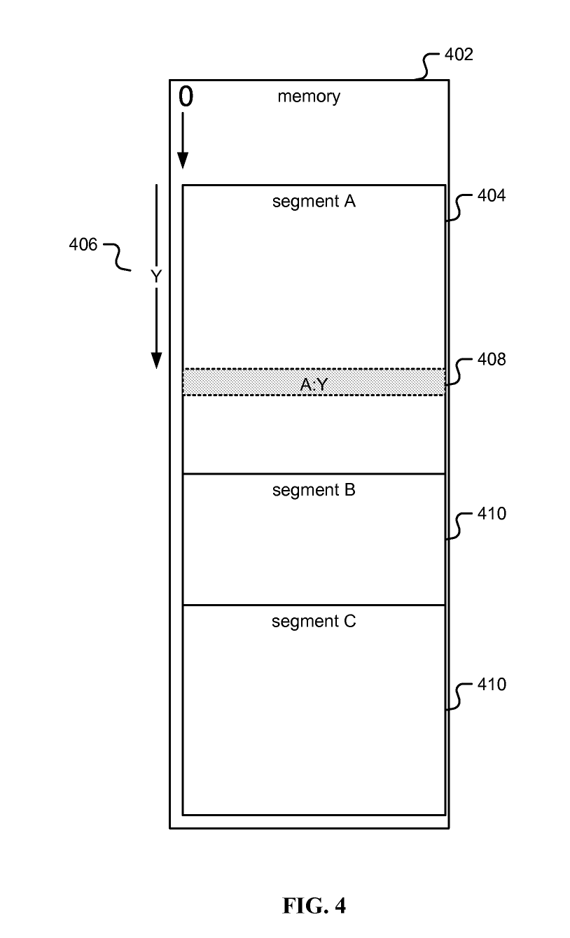

FIG. 4 is an illustration of an example of general segment offset addressing. In the past, so-called segment-offset addressing was used to allow addressing a larger amount of memory than could be addressed using the number of bits that could be stored in a normal processor register. Memory 402 is divided up into segments including segment 404 A and other segments 410 B and C. The convention of FIG. 4 is that memory addresses are increasing from the top of each block towards the bottom. Within segment A addressing may be determined by offset 406 Y. Thus an absolute address can be computed by summing the value associated with a segment A with its offset Y, sometimes denoted as “A:Y” at 408.

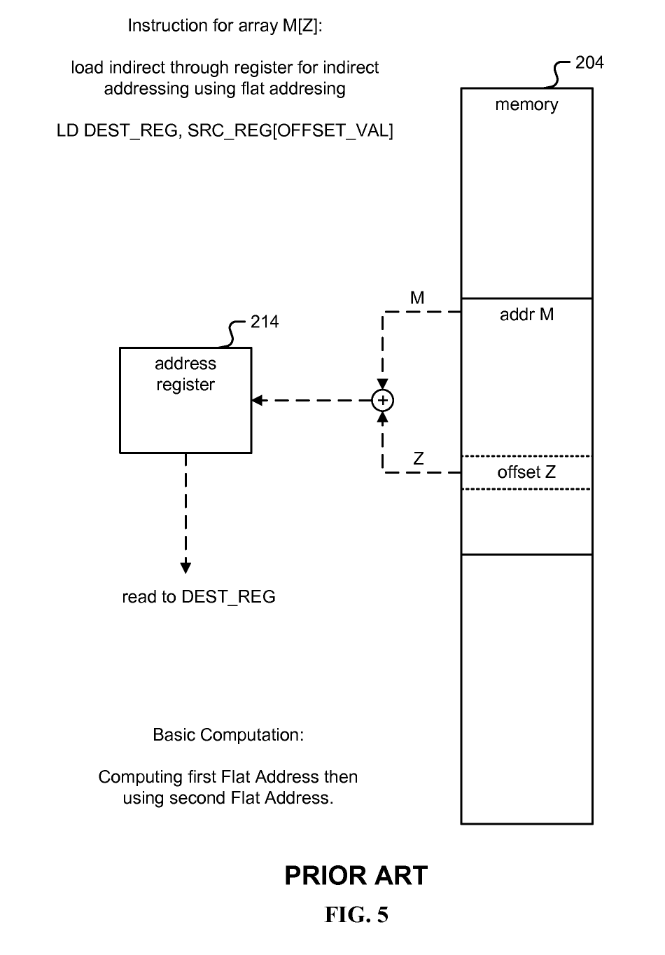

FIG. 5 is an illustration of an indirect addressing instruction for prior flat addressing. Indirect addressing is a residual mechanism of the deprecated segment-offset addressing. In some cases the illustration of FIG. 5 may take place between register bank 208, memory controller 212 and memory 204 of FIG. 2. The ALU 202 receives an instruction for an array N[Z] such that it is configured for indirect addressing through the address register 214 by specifying to load from the address stored in the specified register DEST_REG accessing the location at the flat address that is the sum of: (1) the value contained in the SRC_REG register, for example in this case M, and optionally (2) an offset OFFSET_VA, in this case Z. The basic computation is computing a first flat address then using a second flat address.

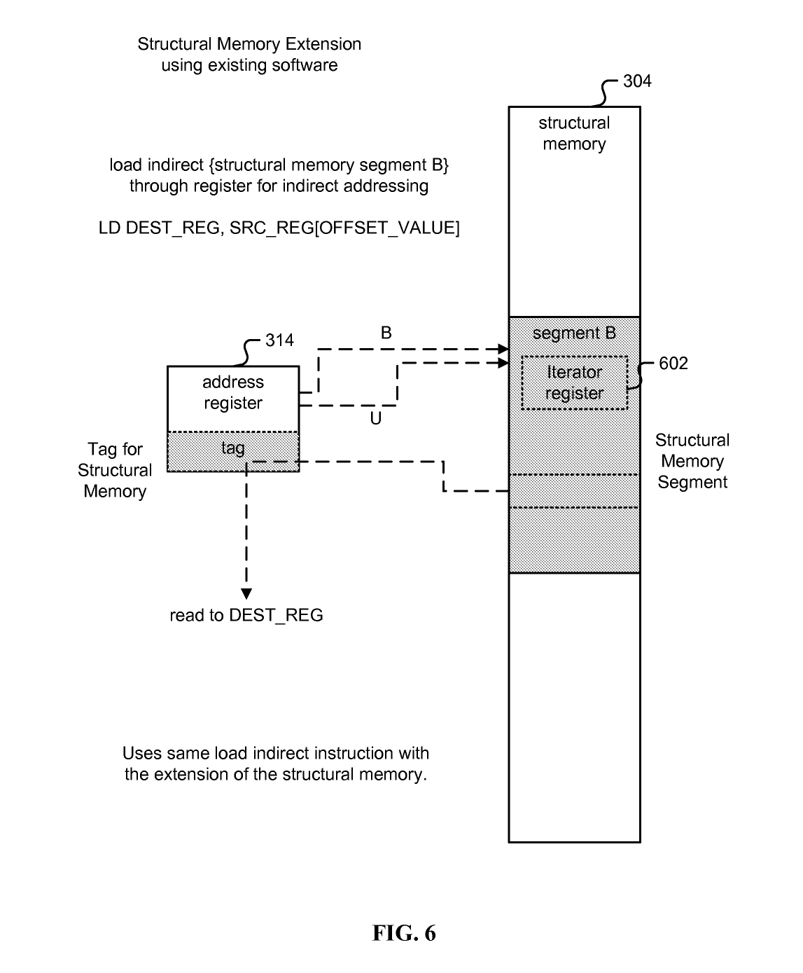

FIG. 6 is an illustration of an indirect addressing load instruction with structured memory using a register tag. While a load is depicted in FIG. 6, without limitation and as described below the techniques may be generalized to move or store instructions.

Providing a tag for a register to indicate that is associated with a special memory access path is disclosed. A tag in address register 314 is set earlier to indicate a special memory access path, for example to structured memory 304.

When a load or move instruction then reads data specified as indirect through this register 314, the processor redirects the access to the said special memory access path with an indication of the segment, for example in this case B, associated with this register and the offset value, in this case U, as stored in this register.

Similarly, on a store indirect through such a register, the data being stored is redirected through the associated specialized memory path with a similar indication of segment and offset.

Example of Structured Memory Segment: the HICAMP Segment. The HICAMP architecture is based on the following key three ideas:
1. content-unique lines: memory is an array of small fixed-size lines, each addressed by a physical line ID, or PLID, with each line in memory having a unique content that is immutable over its lifetime.
2. memory segments and segment map: memory is accessed as a number of segments, where each segment is structured as a DAG of memory lines. Segment table maps each segment to the PLID that represents the root of the DAG. Segments are identified and accessed by Segment IDs (“SegIDs”).
3. iterator registers: special-purpose registers in the processor that allow efficient access to data stored in the segments, including loading data from the DAG, iteration, perfetching and updates of the segment contents.

Content-Unique Lines. The HICAMP main memory is divided into lines, each with a fixed size, such as 16, 32 or 64 bytes. Each line has a unique content that is immutable during its lifetime. Uniqueness and immutability of lines is guaranteed and maintained by a duplicate suppression mechanism in the memory system. In particular, the memory system can either read a line by its PLID, similar to read operations in conventional memory systems, as well as look up by content, instead of writing. Look up by content operation returns a PLID for the memory line, allocating line and assigning it a new PLID if such content was not present before. When the processor needs to modify a line, to effectively write new data into memory, it requests a PLID for a line with the specified/modified content. In some embodiments, a separate portion of the memory operates in conventional memory mode, for thread stacks and other purposes, which can be accessed with conventional read and write operations.

The PLIDs are a hardware-protected data type to ensure that software cannot create them directly. Each word in the memory line and processor registers has alternate tags which indicate whether it contains a PLID and software is precluded from directly storing a PLID in a register or memory line. Consequently and necessarily, HICAMP provides protected references in which an application thread can only access content that it has created or for which the PLID has been explicitly passed to it.

Segments. A variable-sized, logically contiguous block of memory in HICAMP is referred to as a segment and is represented as a directed acyclic graph (“DAG”) constructed of fixed size lines as illustrated in FIG. 3B. The data elements are stored at the leaf lines of the DAG.

Each segment follows a canonical representation in which leaf lines are filled from the left to right. As a consequence of this rule and the duplicate suppression by the memory system, each possible segment content has a unique representation in memory. In particular, if the character string of FIG. 3B is instantiated again by software, the result is a reference to the same DAG which already exists. In this way, the content-uniqueness property is extended to memory segments. Furthermore, two memory segments in HICAMP can be compared for equality in a simple single-instruction comparison of the PLIDs of their root lines, independent of their size.

When contents of a segment are modified by creating a new leaf line, the PLID of the new leaf replaces the old PLID in the parent line. This effectively creates new content for the parent line, consequently acquiring a new PLID for the parent and replacing it in the level above. Continuing this operation, new PLIDs replace the old ones all the way up the DAG until a new PLID for the root is acquired.

Each segment in HICAMP is copy-on-write because of the immutability of the allocated lines, i.e. a line does not change its content after being allocated and initialized until it is freed because of the absence of references to it. Consequently, passing the root PLID for a segment to another thread effectively passes this thread a snapshot and a logical copy of the segment contents. Exploiting this property, concurrent threads can efficiently execute with snapshot isolation; each thread simply needs to save the root PLID of all segments of interest and then reference the segments using the corresponding PLIDs. Therefore, each thread has sequential process semantics in spite of concurrent execution of other threads.

A thread in HICAMP uses non-blocking synchronization to perform safe, atomic update of a large segment by:
1. saving the root PLID for the original segment;
2. modifying the segment updating the contents and producing a new root PLID;
3. using a compare-and-swap (“CAS”) instruction or similar to atomically replace the original root PLID with the new root PLID, if the root PLID for the segment has not been changed by another thread, and otherwise retrying as with conventional CAS.

In effect, the inexpensive logical copy and copy-on-write in HICAMP makes Herlihy's theoretical construction showing CAS as sufficient actually practical to use in real applications. Because of the line-level duplicate suppression, HICAMP maximizes the sharing between the original copy of the segment and the new one. For example, if the string in FIG. 3B was modified to add the extra characters “append to string”, the memory then contains the segment corresponding to the string, sharing all the lines of the original segment, simply extended with additional lines to store the additional content and the extra internal lines necessary to form the DAG.

Iterator Registers. In HICAMP, all memory accesses go through special registers referred to as iterator registers. as described in U.S. patent application Ser. No. 12/842,958 entitled ITERATOR REGISTER FOR STRUCTURED MEMORY (Attorney Docket: HICAP002), which is hereby incorporated by reference in its entirety. An iterator register effectively points to a data element in a segment. It caches the path through the segment from the root PLID of the DAG to the element it is pointing to, as well as element itself, ideally the whole leaf line. Thus, an ALU operation that specifies a source operand as an iterator register accesses the value of the current element the same way as a conventional register operand. The iterator register also allows its current offset, or index within the segment, to be read.

Iterator registers support a special increment operation that moves the iterator register's pointer to the next (non-null) element in the segment. In HICAMP, a leaf line that contains all zeroes is a special line and is always assigned PLID of zero. Thus, an interior line that references this zero line is also identified by PLID zero. Therefore, the hardware can easily detect which portions of the DAG contain zero elements and move the iterator register's position to the next non-zero memory line. Moreover, caching of the path to the current position means that the register only loads new lines on the path to the next element beyond those it already has cached. In the case of the next location being contained in the same line, no memory access is required to access the next element.

Using the knowledge of the DAG structure, the iterator registers can also automatically prefetch memory lines in response to sequential accesses to elements of the segment. Upon loading the iterator register, the register automatically prefetches the lines down to and including the line containing the data element at the specified offset. HICAMP uses a number of optimization and implementation techniques that reduces its associated overheads.

Iterator Registers in Indirect Addressing. In one embodiment, the special memory path is provided in part by one or more iterator registers 602. The register indicates the specific iterator register with which it is associated. The datun returned in response to a load in this embodiment is the datum at the offset specified in the register in the segment associated with this iterator register. A similar behavior applies on storing indirect through a tagged register.

In an embodiment using iterator registers, incrementing the value in a tagged register is indicated to the iterator register implementation causing it to prefetch to the new offset within the segment. Moreover, if the associated segment is sparse, the iterator register may reposition to the next non-null entry rather than the one corresponding to the exact new offset value in the register. In this case, the resulting actual offset value of the next non-null entry is reflected back to this register.

In the HICAMP—SITE example, SITE supports a segment map indexed by virtual segment id (“VSID”), where each entry points to the root physical line identification (“PLID”) of a segment plus flags indicating merge-update, etc. Each iterator register records the VSID of the segment it has loaded and supports conditional commit of the modified segment, updating the segment map entry on commit if it has not changed. If flagged as merge-update, it attempts a merge. Similarly, a region can be synched to its corresponding segment, namely to the last committed state of the segment. The segment table entry can be expanded to hold more previous segments as well as statistics on the segment. VSIDs have either system-wide scope or else scope per segment map, if there are multiple segment maps. This allows segments to be shared between processes. SITE may also interface to a network interconnect such as Infiniband to allow connection to other nodes. This allows efficient RDMA between nodes, including remote checkpoints. SITE may also interface to FLASH memory to allow persistence and logging.

In some embodiments, a basic model of operation is used where SITE is the memory controller and all segment management operations (allocation, conversion, commit, etc.) occur implicitly and are abstracted away from software. In some embodiments, SITE is implemented effectively as a version of a HICAMP processor, but extended with a network connection, where the line read and write operations and “instructions” are generated from requests over a Hyper Transport or QPI or other bus rather than local processor cores. The combination of the Hyper Transport or QPI or other bus interface module and region mapper simply produces line read and write requests against an iterator register, which then interfaces to the rest of the HICAMP memory system/controller 110. In some embodiments, coprocessor 108 extracts VSIDs from the (physical) memory address of the memory request sent by the processor 102. In some embodiments, SITE includes a processor/microcontroller to implement, for example, notification, merge-update, and configuration in firmware, thus not requiring hardware logic.

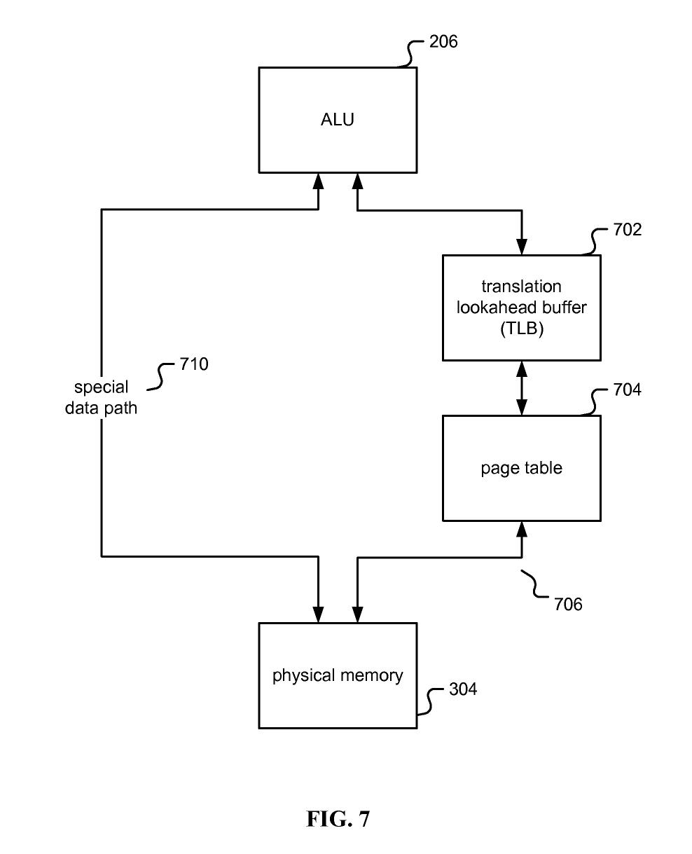

FIG. 7 is an illustration of the efficiencies of a structured memory extension. The ALU 206 and physical memory 304 may be the same as in FIG. 3. In an embodiment, an indirect load from tagged register is implemented by redirecting the access to a special data path 710 that is different from path 706 going to the processor TLB 702 and/or conventional processor cache 310 (not shown in FIG. 7). This special path determines the data to return from state associated with this special path.

In an embodiment using an iterator register implementation, the iterator register implementation translates the register offset to the corresponding location in the segment and determines the means to access this datum. In an embodiment, the iterator register implementation manages a separate on-chip memory of lines corresponding to those required or expected to be required by the iterator register. In another embodiment, the iterator register implementation shares the conventional on-chip processor cache memory or memories, but imposes a separate replacement policy or aging indication on the lines that it is using. In particular, it may immediately flush lines from the cache that the iterator register implementation no longer expects to need.

In an embodiment, entries in a virtual memory page table 704 can indicate when one or more virtual addresses correspond to a special memory access path and its associated data segment. That is, the entry is tagged as special and the physical address associated with the entry is interpreted as specifying a data segment accessible via this special memory path. In this embodiment, when a register is loaded from such a virtual address, the register is tagged as using a special memory access path and associated with the data segment specified by the associated page table entry. In some embodiments this includes setting the tag in the register to be used as a segment register, by loading that register from a specially tagged portion of virtual memory.

In an embodiment, the conventional page table (also shown as 704) can be used to control access to data segments and read/write access to the segment, similar to its use for these purposes with flat addressing. In particular, a register tagged with the special access indication can further indicate whether read or write access or both is allowed through this register, as determined from the page table entry permissions. Moreover, the operating system can carefully control the access to segments provided through per-process or per-thread page tables.

In an embodiment, the special memory access path 710 provides a separate mapping from offset to memory, obviating the need to translate a flat address on each access through said tagged register from a virtual address to a physical address. It thereby reduces the demand on the TLB 702 and virtual memory page tables 704. For example, in an embodiment using HICAMP memory structures, the segment can be represented as a tree or DAG of indirect data lines that reference either other such indirect data lines or the actual data lines.

In an embodiment, a tagged register can be saved using one of the atomic operations of the processor, such as compare-and-swap, or by embedding the store into a hardware transactional memory transaction, thereby providing atomic update of a data segment relative to other concurrent threads of execution. Here, “saved” refers to updating the separate data access path implementation of a segment to reflect the modifications performed using the tagged register.

That is, several structured memories including HICAMP have the property wherein transient lines/state are associated with a segment/iterator register, so that the state may be committed by atomically updating the iterator register. Thus a means is provided to trigger a structured memory atomic update of a segment. The means is integrated with the atomic/transactional mechanisms of the conventional architecture. When the processor wants to signal the structured memory to perform an atomic update, it can do so through the tagged register.

Commit of a transactional update can be thus caused by an update of a tagged register. The hardware transactional memory will capture memory capacity of arbitrary size, including terabytes, i.e. trillions, and transactions that update segments of that size. For example, other (more conventional) processors may have transactional memory referred to as restricted transactional memory because of the restriction on size of data that a hardware transactional memory transaction that is permitted by the other processor. In some embodiments, additional tagging can further reflect that the structured memory is to be committed atomically.

In an embodiment using tagged virtual page table entries, this atomic action be realized by storing a tagged register to a virtual memory address corresponding to a tagged location, as specified by the corresponding virtual page table entry.

In an embodiment, there can be multiple tagged registers at a given time that represent modified data as part of a logical application transaction and these multiple register can be atomically committed using the mechanisms above.

In an embodiment, the data segment access state can be accessed directly by the operating system software to allow it to be saved and restored on context switch, as well as transferred between registers as needed by the application. In an embodiment, this facility is provided by protected specialized hardware registers in the processor that only the operating system can access. In an embodiment, additional hardware can be provided to optimize these operations.

In an embodiment, a tagged register can provide access to a structured data segment, such as a key-value store. In this case, the value in the tagged register can be interpreted as a pointer to a character string if character strings are used as keys to this store. In this case, the key itself logically designates the offset within the segment. In some embodiments, the offset is to be generally translated to a value of the key-value pair.

As an example, one key-value store may reflect a dictionary, such that the key “cow” refers to a value “a female of a mature bovine animal”. In this case the structured data segment has “cow” as its (index) offset, for example in reference to FIG. 6. The structured memory retains all of its capabilities including its content-addressable nature such that “cow”, being a string rather than an integer, is simply/natively indexed via, for example a HICAMP PLID, to a PLID integer as an index which directly/indirectly returns the “a female of a mature bovine animal” value of the key-value pair.

Thus, in various embodiments the operation on key-value stores may return either the value of the structured memory segment, or the index/PLID of the structured memory segment pointing to the value of the key-value pair. String offsets are simply handled, in some cases without software interpretation/translation, by the structured memory retaining the benefit of handling sparse data sets. In some embodiments, additional tagging can further reflect that the structured memory is to be treated as a key-value store rather than an array of integers.

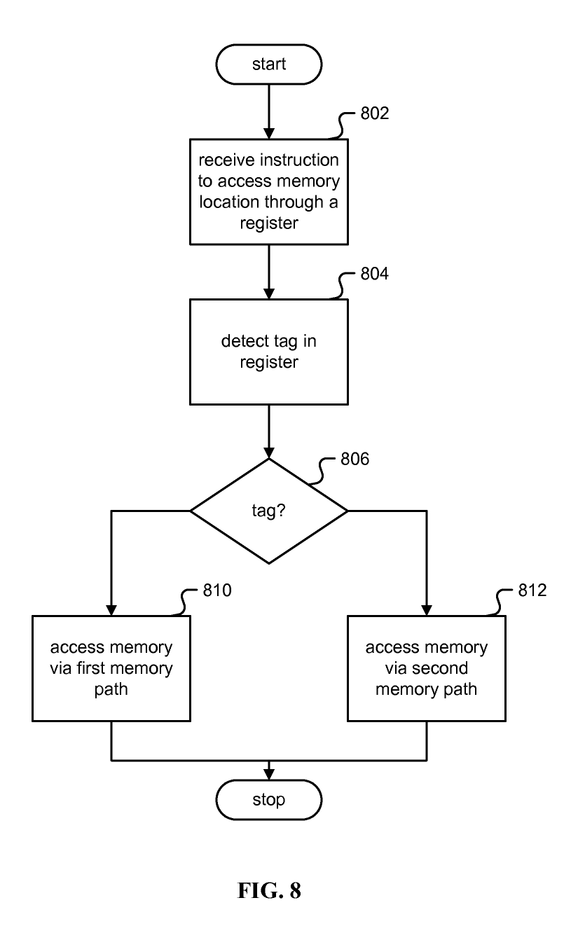

FIG. 8 is a block diagram illustrating an embodiment of the special memory block using segment-offset addressing. In step 802, an instruction is received to access a memory location through a register. In some embodiments this includes an indirect load, an indirect move, or an indirect store instruction. In step 804, a tag is detected in the register. The tag is configured to indicate by implicit or explicit means which type of memory to access via which data path (e.g., conventional or special/structured). In the event in step 806 that the tag is configured to indicate that a first/structured memory path is used, control is transferred to step 810 and memory is accessed via the first memory path. Likewise, in the event in step 806 that the tag is configured to indicate that a second/conventional memory path is used, control is transferred to step 812 and memory is accessed via the second memory path.

The memory referred to in FIG. 8 may be the same as the partitioned memory 304 in FIG. 3. The paths referred to in FIG. 8 may be the paths as the paths 706/710 in FIG. 7. The memory 304 may support different address sizes, for example the first/structured memory may have an address size of 32-bits and the second/conventional memory may be addressed by 64-bits. In some embodiments, accessing the first type of memory may require address translation wherein to access the second type of memory may not require address translation. In some embodiments, a cache 310 may be partitioned into a first type of cache for the first memory path and a second type of cache for the second memory path. In some embodiments, cache 310 will not be used as much for the first memory path.

The segment-offset addressing through a tagged register to a special memory access path allows for:
1. reduced load on TLBs 702 and page table 704 access;
2. reduced load on the normal data cache 310 for accessing certain datasets;
3. reduced need for large addresses, such as the 64-bit addressing extension to many processors; and
4. the addressing disclosed eliminates the need to relocate a data set, as arises with flat addressing, when the dataset grows beyond that expected or conversely, eliminates the need for maximal allocation of a virtual address range for each segment when the size is not known in advance.

Moreover, it allows specialized memory support along this memory access path, such as the HICAMP capabilities of deduplication, snapshot access, atomic update, compression and encryption.

A common computational pattern is “map” and “reduce”. A “map” computation maps from a collection to another collection. With this invention, this form of computation can be effectively realized as computing from a source segment into a destination segment using this proposal. The “reduce” computation is just from a collection to a value, so using a source segment as an input to the computation.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A memory access method for accessing a memory subsystem, comprising:
receiving an instruction to access a memory location through a register;
detecting a tag in the register, the tag being configured to indicate which memory path to access;
in the event that the tag is configured to indicate that a first memory path is used, accessing the memory subsystem via the first memory path; and
in the event that the tag is configured to indicate that a second memory path is used, accessing the memory subsystem via the second memory path.

2. The method as recited in claim 1, wherein the instruction is one or more of the following:
an indirect load, an indirect move, and an indirect store.

3. The method as recited in claim 1, wherein the memory subsystem is partitioned into a first type of memory to be accessed by the first memory path and a second type of memory accessed by the second memory path.

4. The method as recited in claim 3, wherein the first type of memory is a structured memory and the second type of memory is a conventional memory.

5. The method as recited in claim 3, wherein the first type of memory and second type of memory have different addressing sizes.

6. The method as recited in claim 1, further comprising setting the tag in the register by loading the register from a tagged portion of memory.

7. The method as recited in claim 3, wherein permission to access the first type of memory is determined prior to the instruction is invoked, and permission to access the second type of memory is determined after the instruction is invoked.

8. The method as recited in claim 3, wherein the first type of memory supports snapshots.

9. The method as recited in claim 3, wherein the first type of memory supports atomic update.

10. The method as recited in claim 3, wherein the first type of memory supports deduplication.

11. The method as recited in claim 3, wherein the first type of memory supports sparse dataset access.

12. The method as recited in claim 3, wherein the first type of memory supports compression.

13. The method as recited in claim 3, wherein the first type of memory supports structured data including a key-value store.

14. The method as recited in claim 3, wherein to access the second type of memory requires address translation and wherein to access the first type of memory does not require address translation.

15. The method as recited in claim 1, a first type of cache is used for the first memory path, and a second type of cache is used for the second memory path.

16. The method as recited in claim 1, further comprising that in the event that the register is to be reused, saving the register state, reusing the register, and when the reuse operation is completed, reloading the saved register state.

17. The method as recited in claim 1, further comprising detecting whether the tag indicates that the offset is to be translated to a value of a key-value pair.

18. The method as recited in claim 1, wherein a memory path is a path from a processor to a part of the memory subsystem.

19. A method of accessing a dataset through a special memory access path, comprising:
loading a register with an indication of the memory segment reflecting the special memory path;
providing an offset indication associated with said register;
extracting a value at the associated offset by reference to this register; and
wherein said special memory path provides a special memory data path, such that the value is provided to a processor by a data path other than the data path used by normal load and store operations.

20. A system for accessing a memory subsystem, comprising:
a memory subsystem;
a register coupled to the memory subsystem that includes a tag;
wherein instructions are received to access a memory location through the register; and
wherein the tag is configured to indicate which type of memory to access by a tag value;
a memory controller configured to:
detect a tag in the register;
in the event that the tag value is present or the tag is configured to indicate that a first memory path is used, access the memory subsystem via the first memory path; and
in the event that the tag value is not present or the tag is configured to indicate that a second memory path is used, access the memory subsystem via the second memory path.
